(19) United States
(12) Patent Application Publication
(10) Pub. No.: US 2025/0310923 A1
(43) Pub. Date: Oct. 2, 2025

(54) METHOD FOR NETWORK ASSISTED RANGING AND/OR SIDELINK POSITIONING, TERMINAL AND SOFTWARE

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 18/863,112

(22) PCT Filed: May 6, 2022
(86) PCT No.: PCT/CN2022/091327

§ 371 Date: Nov. 5, 2024

(51) Int. Cl. H04W 64/00; H04W 4/029

(52) U.S. Cl. CPC H04W 64/00; H04W 4/029

(57) ABSTRACT

A method for network assisted ranging and/or sidelink positioning includes: receiving, by an AMF, one or more registration requests; receiving, by a GMLC, a LCS service request; determining, by a 5 5GC NF entity the target UE is out of 5G coverage; selecting, by the GMLC, a serving AMF of the target UE; transmitting, by the GMLC, the LCS service request to the serving AMF; selecting, by the AMF, at least one network assisted UE and a LMF capable of network assisted sidelink positioning; transmitting, by the AMF, the LCS service request to the LMF; performing, by the LMF and the network assisted UE, ranging and/or sidelink positioning procedure; generating and transmitting, by the LMF, an LCS location estimation; transmitting, by the LMF, the LCS location estimation of the target UE to the GMLC; transmitting, by the GMLC, the LCS location estimation to the requesting device.

### CROSS-REFERENCE TO RELATED APPLICATIONS

The present application is a U.S. National Stage of International Application No. PCT/CN2022/091327, filed on May 6, 2022, the content of which is incorporated herein by reference in its entirety for all purposes.

### TECHNICAL FIELD

The present application generally relates to wireless technology. In particular, the present application relates to a method for network assisted ranging and/or sidelink positioning, a method for preparing network assisted ranging and/or sidelink positioning as well as network device and a software for network assisted ranging and/or sidelink positioning.

### BACKGROUND

Positioning has always been a core part of cellular technology. Sidelink positioning brings flexibility to positioning in different operational scenarios with multiple spectrum options.

As such, there is a need to use wireless communication system such as New Radio (NR) cellular technologies to assist in accurate and efficient ranging or sidelink positioning.

Ranging refers to the determination of the distance between two User Equipments (UEs) or more UEs and/or the direction and/or relative positioning of one UE (i.e., Target UE) from another UE (i.e., Reference UE) via PC5 interface. PC5 refers to a reference point where the User Equipment (UE), e.g., mobile handset, directly communicates with another UE over the direct channel. In this case, the communication with the base station is not required. “sidelink positioning” is the terminology to refer to the direct positioning of UE over PC5.

The location management function (LMF) is central in the 5G positioning architecture. The LMF receives measurements and assistance information from the next generation radio access network (NG-RAN) and the mobile device, otherwise known as the user equipment (UE), via the access and mobility management function (AMF) to compute the position of the UE.

Ranging-based services and sidelink positioning consists of distance measurement, direction measurement, or both. UE is allowed to request the distance measurement only, the direction measurement only, or both in the service.

Ranging and/or sidelink positioning service can be supported with or without 5G coverage. Uu-based positioning refers to methods of using positioning reference signals (PRS) over the 5G New Radio (NR) air interface (Uu) to estimate the position of a 5G device. When a UE is not able to perform Uu-based positioning estimation, the UE may be out of network coverage, or have network coverage but not able to measure on enough gNodeBs (gNBs) to perform Uu-based positioning. In this case, the UE (i.e., partial coverage or in network coverage) may use Sidelink Positioning to obtain relative positioning with a second UE which is in network coverage. This case is referred to as Sidelink Positioning which is also known as Network assisted Sidelink Positioning.

### SUMMARY

In an aspect of the present disclosure, a method for network assisted ranging and/or sidelink positioning is provided, the method includes: receiving, by an Access and Mobility Management Function, AMF, one or more registration requests from at least one User Equipment, UE; receiving, by a Gateway Mobile Location Centre, GMLC, a Location Service, LCS, service request from a requesting device, wherein the LCS service request includes information on a target UE; determining, by a 5G Core Network Function, 5GC NF, entity, that the target UE is out of 5G coverage based on a serving AMF address retrieval result or a paging result; selecting, by the GMLC, a serving AMF of the target UE based on the AMF address retrieval result; transmitting, by the GMLC, the LCS service request to the serving AMF; obtaining, by the serving AMF, at least one of: capability information of the at least one UE, cell ID, gNB ID, Tracking Area ID, or the last known ID of a target area; selecting, by the serving AMF, at least one network assisted UE based on at least one of: capability information of the at least one UE, cell ID, gNB ID, Tracking Area ID, the last known ID of the target area, or a pre-configuration information; selecting, by the serving AMF, a Location Management Function, LMF, capable of network assisted sidelink positioning; transmitting, by the AMF, the LCS service request to the LMF, wherein the LCS service request includes a target UE ID and the at least one network assisted UE ID; performing, by the LMF and the at least one network assisted UE, ranging and/or sidelink positioning procedure; generating, by the LMF, an LCS location estimation; transmitting, by the LMF, the LCS location estimation of the target UE to the GMLC; and transmitting, by the GMLC, the LCS location estimation to the requesting device.

In an aspect of the present disclosure, a method for preparing a network assisted ranging and/or sidelink positioning is provide, the method includes: receiving, one or more registration requests from at least one User Equipment, UE; receiving, from a Gateway Mobile Location Centre, GMLC, a Location Service, LCS, service request, wherein the LCS service request includes information on a target UE; obtaining at least one of: capability information of the at least one UE, cell ID, gNB ID, Tracking Area ID, the last known ID of a target area; selecting at least one network assisted UE based on at least one of: capability information of the at least one UE, cell ID, gNB ID, Tracking Area ID, the last known ID of the target area, a pre-configuration information; selecting a Location Management Function, LMF, capable of network assisted sidelink positioning; transmitting the LCS service request to the LMF, wherein the LCS service request includes a target UE ID and the at least one network assisted UE ID.

In an aspect of the present disclosure, a method for network assisted ranging and/or sidelink positioning is provided, the method includes: receiving, by the LMF, from an Access and Mobility Management Function, AMF, a Location Service, LCS, service request, wherein the LCS service request includes a target UE ID and at least one network assisted UE ID; performing, by the LMF and the at least one network assisted UE, ranging and/or sidelink positioning procedure; generating, by the LMF, a LCS location estimation; transmitting, by the LMF, the LCS location estimation of the target UE to a Gateway Mobile Location Centre, GMLC entity.

In an aspect of the present disclosure, an Access and Mobility Management Function, AMF, entity, is provided, including: a processor and a memory storage device, wherein in the memory storage device instructions executable by the processor are stored that, when executed, cause the processor to perform the above-described method for preparing of network assisted ranging and/or sidelink positioning.

In an aspect of the present disclosure, a non-transitory computer-readable storage medium is provided storing processor-executed instructions that, when executed by a processor, cause the processor to perform the above-described methods.

In an aspect of the present disclosure, a system for network assisted ranging and/or sidelink positioning is provide, the system includes at least one UE and at least one 5G core Network Function, 5GC NF entity, the system is configured to perform the method according to the method for network assisted ranging and/or sidelink positioning.

In an aspect of the present disclosure, a further system for network assisted ranging and/or sidelink positioning is provided. The system includes at least one Location Management Function, LMF entity and at least one network assisted User Equipment, UE, the system is configured to perform the network assisted ranging and/or sidelink positioning method.

### BRIEF DESCRIPTION OF THE DRAWINGS

Reference will now be made, by way of example, to the accompanying drawings which show example embodiments of the present application, and in which:

FIG. 1 shows a schematic diagram illustrating UE to UE communication via sidelink channel with PC5 interface,

FIG. 2 shows a schematic diagram illustrating different relationships between UEs and the 5G network;

FIG. 3 shows a sequence diagram illustrating a detailed embodiment according to the present disclosure illustrating the 5GC-MT-LR Procedure when target UE is out of coverage; and

FIG. 4 shows a schematic illustration of an AMF entity.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

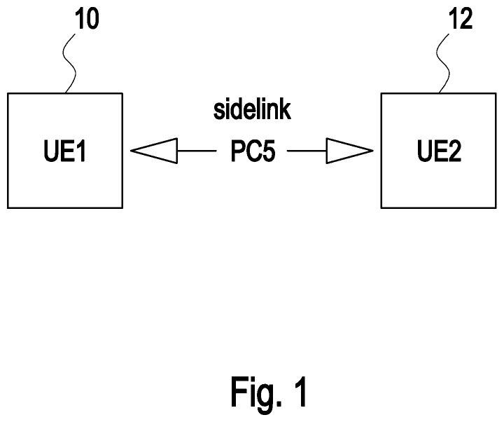

FIG. 1 shows a schematic diagram illustrating UE to UE communication via sidelink channel with PC5 interface. PC5 refers to a reference point where the User Equipment (UE), e.g., mobile handset, directly communicates with another UE over the direct channel. In this case, the communication with the base station is not required. “sidelink positioning” is the terminology to refer to the direct positioning of UE over PC5.

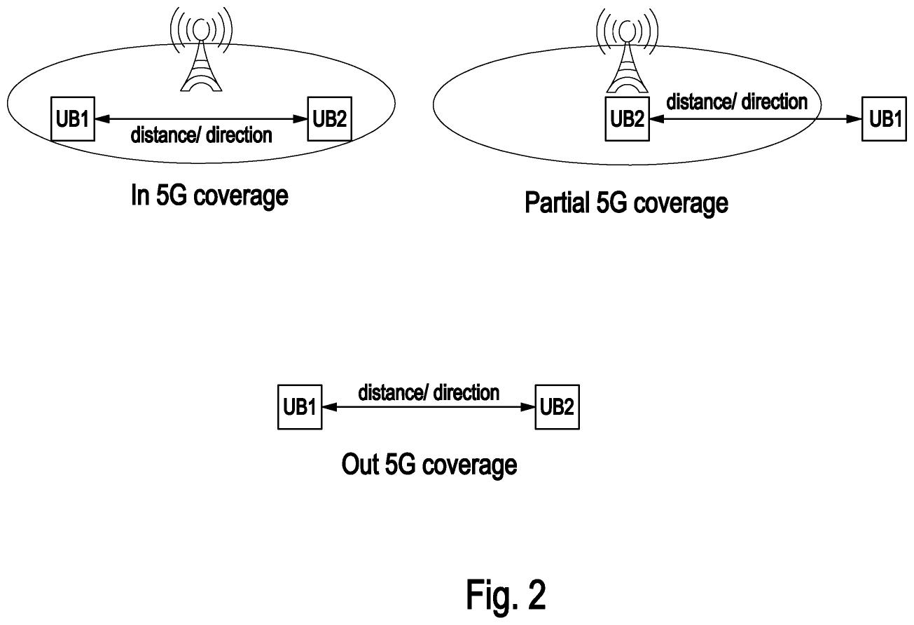

Referring to FIG. 2. FIG. 2 shows a schematic diagram illustrating different relationships between UEs and the 5G network. Ranging and/or sidelink positioning service can be supported with or without 5G coverage. FIG. 2 is an illustration of 5G providing ranging service to UEs with or without 5G coverage. If licensed band is used for ranging, it shall be fully under operator control. The present disclosure addresses the case when a UE is not able to perform Uu based positioning estimation. The UE may be out of network coverage, or have network coverage but not able to measure on enough gNBs to perform Uu based positioning. In this case, the UE (i.e. partial coverage or in network coverage) may use Sidelink Positioning to obtain relative positioning with a second UE which is in network coverage. Which is also known as Network assisted Sidelink Positioning.

In the above use cases, the following aspects need to be studied:
Discovery of the second UE with capabilities that offers sidelink Positioning and/or Uu based positioning to support Network assisted sidelink positioning in network coverage and partial network coverage. The second UE is also known as network assisted UE.
Discovery of network capability that offers Network assisted Sidelink positioning for UE in network coverage and partial network coverage.
Signalling needed to support Sidelink positioning including both UE-based positioning and network-assisted/based positioning.

However, the solution for ranging and/or positioning a UE out of network coverage in a 5G core Mobile Terminated Location Request (5GC-MT-LR) procedure is still missing.

Therefore, the challenges may include how to select serving Access and Mobility Management Function (AMF) for positioning of a target UE after it is deregistered. How to discover the second UE (i.e., network assisted UE) when the target UE is out of coverage. How to determine when to trigger Network assisted ranging and/or sidelink Positioning to locate a UE and What are the signaling procedure to locate a UE with the help of the second UE (i.e., network assisted UE).

Thus, it is an object of the present disclosure to provide solutions for the above challenges.

In an aspect of the present disclosure, a method for network assisted ranging and/or sidelink positioning is provided, the method includes: receiving, by an Access and Mobility Management Function, AMF, one or more registration requests from at least one User Equipment, UE; receiving, by a Gateway Mobile Location Centre, GMLC, a Location Service, LCS, service request from a requesting device, wherein the LCS service request includes information on a target UE; determining, by a 5G Core Network Function, 5GC NF, entity, that the target UE is out of 5G coverage based on a serving AMF address retrieval result or a paging result; selecting, by the GMLC, a serving AMF of the target UE based on the AMF address retrieval result; transmitting, by the GMLC, the LCS service request to the serving AMF; obtaining, by the serving AMF, at least one of: capability information of the at least one UE, cell ID, gNB ID, Tracking Area ID, or the last known ID of a target area; selecting, by the serving AMF, at least one network assisted UE based on at least one of: capability information of the at least one UE, cell ID, gNB ID, Tracking Area ID, the last known ID of the target area, or a pre-configuration information; selecting, by the serving AMF, a Location Management Function, LMF, capable of network assisted sidelink positioning; transmitting, by the AMF, the LCS service request to the LMF, wherein the LCS service request includes a target UE ID and the at least one network assisted UE ID; performing, by the LMF and the at least one network assisted UE, ranging and/or sidelink positioning procedure; generating, by the LMF, an LCS location estimation; transmitting, by the LMF, the LCS location estimation of the target UE to the GMLC; and transmitting, by the GMLC, the LCS location estimation to the requesting device.

According to the method provided in the above aspect of the present disclosure, capability information may be included in the registration request of the UE. In particular, the UE provides its network assisted ranging and/or sidelink positioning capability information to the AMF, and the AMF stores it in the UE context. Hereafter, a LCS service request is received from a requesting device. The requesting device may be e.g., Application Function (AF)/LCS client or other device which is configured to transmit a LCS service request. The LCS service request includes information on a target UE so that it is possible for a 5GC NF to determine whether to trigger the network assisted ranging and/or positioning procedure. The determination might be based either on a serving AMF address retrieval result or a paging result. In particular, when GMLC retrieves AMF address from the UDM with SUPI of this UE and no network address of the current serving AMF is returned or paging couldn't be successful (e.g., when UE is in CM-IDLE state). In either of the above two cases, the network assisted sidelink positioning may be triggered. The GMLC then selects a serving AMF for the target UE based on the AMF address retrieval result. In particular, if no AMF address is returned and a target area is provided in the LCS service request, GMLC maps the target area into Cell ID/gNB ID/TAI, based on which derives the serving AMF which can serve that area as the serving AMF of the network assisted UE. If an AMF address is returned, the GMLC selects the AMF as the serving AMF of the target UE. Hereafter, the LCS service request is transmitted to the serving AMF. Then the AMF obtain at least one of: capability information of the at least one UE, cell ID, gNB ID, Tracking Area ID, the last known ID of a target area. Such information may either be included in the UE registration request or the LCS service request. The AMF then selects at least one network assisted UE based on the above obtained information and a pre-configuration information. Therein, the pre-configuration information might be a selected list of UEs stored at the AMF. Preferably, the list of UEs are candidate network assisted UEs which are selected by the AMF based on UE capability information. Hereafter, the AMF selects a capable LMF for network assisted ranging and/or sidelink positioning and transmits the LCS service request to the selected LMF. Wherein, the LCS service request includes a target UE ID and the at least one network assisted UE ID so that the LMF is able to perform ranging and/or sidelink positioning with the at least one network assisted UE according to information given in the LCS service request. Finally, the result of calculation or estimation will be transmitted to the requesting device either directly or via the GMLC. Thereby, the requesting device gets an LCS location estimation with the help of network assisted UE.

In some embodiments of the present disclosure, the step of generating, by the LMF, the LCS location estimation further includes: obtaining an intermediate result from the ranging and/or sidelink positioning procedure, wherein the intermediate result includes at least one of: the ranging and/or sidelink positioning result, measurement data between the target UE and the at least one network assisted UE, Uu positioning result, Uu measurement data of the at least one network assisted UE; generating the LCS location estimation based on the intermediate result.

According to the method provided in the above embodiments of the present disclosure, depending on the capability of the network assisted UEs, the intermediate result provided by them might also be different. The LCS location estimation might be determined based on the intermediate results either alone or in combination.

In some embodiments of the present disclosure, the step of performing, by the LMF and the at least one network assisted UE, ranging and/or sidelink positioning procedure includes: discovering, by the at least network assisted UE, the target UE; terminating, by the LMF, the discovering step if at least one report of successful discovery is received or terminating, by the LMF, the discovering step based on quality of service, QoS, requirement or a pre-configuration.

According to the method provided in the above embodiments of the present disclosure, the LMF might decide when to terminate the discovering of the target UE. In particular, the discovery might be directly terminated upon one successful report from the network assisted UE is received. Thus, the requesting device can get a the final LCS location estimation in a timely manner. Alternatively, the discovery might be terminated upon the QoS requirements are met or any criterion in a pre-configuration is met. The pre-configuration might contain any customized criterion to terminate the discovery.

In some embodiments of the present disclosure, the LCS request further includes information on a target area and the method further includes: mapping, by the GMLC, the information on the target area into at least one of: cell ID, gNB ID, Tracking Area ID; the selecting, by the GMLC, the serving AMF of the target UE based on the AMF address retrieval result further includes: selecting, by the GMLC, the serving AMF of the target UE based on at least one of: cell ID, gNB ID, Tracking Area ID if no network address of the AMF is retrieved.

According to the method provided in the above embodiments of the present disclosure, since the GMLC contains functionality required to support location-based service (LBS), it is possible to map information on the target area into different IDs as described above. Hereafter, a serving AMF can be properly selected based on the derived IDs.

In some embodiments of the present disclosure, the capability information of the at least one UE is included in the registration request. In some embodiments of the present disclosure, the capability information is stored as the UE context of the at least one UE by the AMF.

In some embodiments of the present disclosure, the method further includes: checking, by the GMLC, service authorization and privacy with a Unified Data Management, UDM, upon receiving the LCS service request. Thus, the service security is improved.

In an aspect of the present disclosure, a method for preparing a network assisted ranging and/or sidelink positioning is provide, the method includes: receiving, one or more registration requests from at least one User Equipment, UE; receiving, from a Gateway Mobile Location Centre, GMLC, a Location Service, LCS, service request, wherein the LCS service request includes information on a target UE; obtaining at least one of: capability information of the at least one UE, cell ID, gNB ID, Tracking Area ID, the last known ID of a target area; selecting at least one network assisted UE based on at least one of: capability information of the at least one UE, cell ID, gNB ID, Tracking Area ID, the last known ID of the target area, a pre-configuration information; selecting a Location Management Function, LMF, capable of network assisted sidelink positioning; transmitting the LCS service request to the LMF, wherein the LCS service request includes a target UE ID and the at least one network assisted UE ID.

Thus, according to the method for preparing the network assisted ranging and/or sidelink positioning, the AMF is able to obtain, derive and transmit all the necessary information for a LMF to perform network assisted ranging and/or positioning with the network assisted UEs.

In some embodiments of the present disclosure, the capability information of the at least one UE is included in the registration request.

In an aspect of the present disclosure, a method for network assisted ranging and/or sidelink positioning is provided, the method includes: receiving, by the LMF, from an Access and Mobility Management Function, AMF, a Location Service, LCS, service request, wherein the LCS service request includes a target UE ID and at least one network assisted UE ID; performing, by the LMF and the at least one network assisted UE, ranging and/or sidelink positioning procedure; generating, by the LMF, a LCS location estimation; transmitting, by the LMF, the LCS location estimation of the target UE to a Gateway Mobile Location Centre, GMLC entity.

According to the method provided in the above aspect of the present disclosure, the method is performed by LMF and at least one network assisted UE. With all the necessary information prepared by the AMF, the LMF is able to initiate and coordinate with the selected network assisted UE(s) to perform ranging and/or sidelink positioning procedure. Thereby, generating and transmitting a LCS location estimation to the GMLC or directly to the requesting device.

In some embodiments of the present disclosure, the step of generating, by the LMF, the LCS location estimation further includes: obtaining an intermediate result from the ranging and/or sidelink positioning procedure, wherein the intermediate result includes at least one of: the ranging and/or sidelink positioning result, measurement data between the target UE and the at least one network assisted UE, Uu positioning result, Uu measurement data of the at least one network assisted UE; generating the LCS location estimation based on the intermediate result.

According to the method provided in the above embodiments of the present disclosure, depending on the capability of the network assisted UEs, the intermediate result provided by them might also be different. The LCS location estimation might be determined based on the intermediate results either alone or in combination.

In some embodiments of the present disclosure, the step of performing, by the LMF and the at least one network assisted UE, ranging and/or sidelink positioning procedure includes: discovering, by the at least network assisted UE, the target UE; terminating, by the LMF, the discovering step if at least one report of successful discovery is received or terminating, by the LMF, the discovering step based on quality of service, QoS, requirement or a pre-configuration.

According to the method provided in the above embodiments of the present disclosure, the LMF might decide when to terminate the discovering of the target UE. In particular, the discovery might be directly terminated upon one successful report from the network assisted UE is received. Thus, the requesting device can get a the final LCS location estimation in a timely manner. Alternatively, the discovery might be terminated upon the QoS requirements are met or any criterion in a pre-configuration is met. The pre-configuration might contain any customized criterion to terminate the discovery.

In an aspect of the present disclosure, an Access and Mobility Management Function, AMF, entity, is provided, including: a processor and a memory storage device, wherein in the memory storage device instructions executable by the processor are stored that, when executed, cause the processor to perform the above-described method for preparing of network assisted ranging and/or sidelink positioning.

In an aspect of the present disclosure, there is provided a non-transitory computer-readable storage medium storing processor-executed instructions that, when executed by a processor, cause the processor to perform the above-described methods.

In an aspect of the present disclosure, a system for network assisted ranging and/or sidelink positioning is provide, the system includes at least one UE and at least one 5G core Network Function, 5GC NF entity, the system is configured to perform the method according to the method for network assisted ranging and/or sidelink positioning.

In an aspect of the present disclosure, a system for network assisted ranging and/or sidelink positioning is provided. The system includes at least one Location Management Function, LMF entity and at least one network assisted User Equipment, UE, the system is configured to perform the network assisted ranging and/or sidelink positioning method.

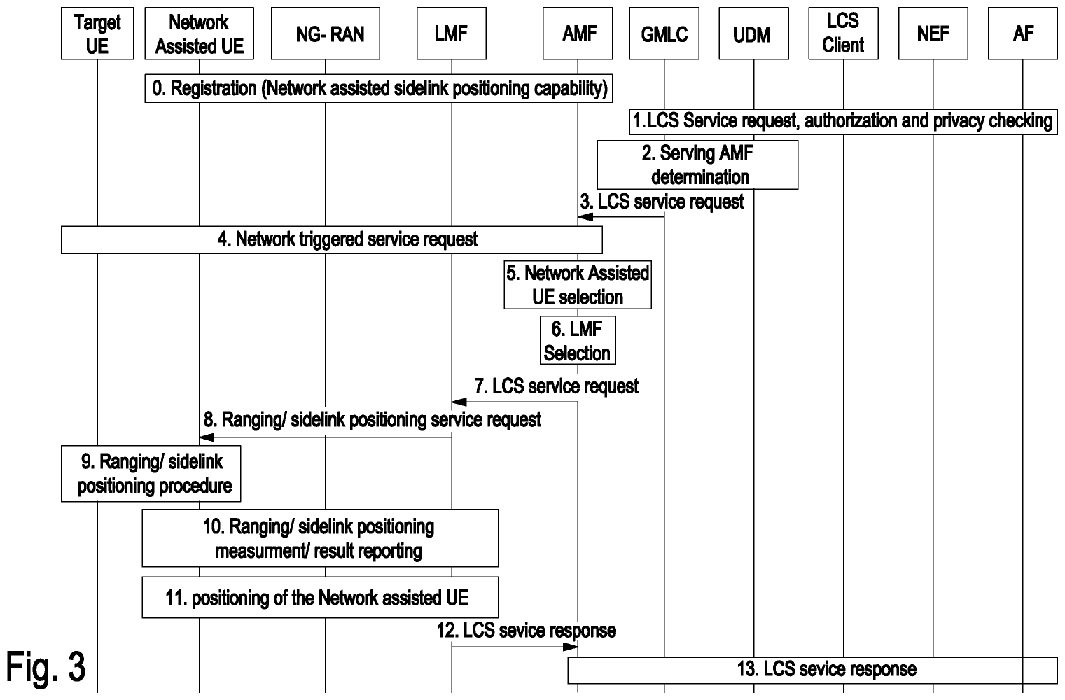

Reference is now made to FIG. 3 shows a sequence diagram illustrating a detailed embodiment according to the present disclosure illustrating the 5GC-MT-LR Procedure when target UE is out of coverage.

In step 0: At least one UE provides its Network assisted ranging and/or sidelink positioning capability in the registration request to the AMF, and the AMF stores it in the UE context.

In step 1: The GMLC (Gateway Mobile Location Centre) receives a LCS (location services) service request from the application function (AF)/LCS client, the request may include a target area the target UE presents. Preferably, the GMLC checks service authorization and privacy with UDM (Unified Data Management).

In step 2: The GMLC retrieves the network address of the serving AMF (Access and Mobility Management Function) of target UE from UDM. If no AMF address is returned and a target area is provided in the LCS service request, GMLC determines to use Network assisted sidelink positioning to locate the target UE. GMLC maps the target area into Cell ID/gNB ID/TAI, based on which derives the serving AMF which can serve that area as the serving AMF of the network assisted UE.

If an AMF address is returned, the GMLC selects the AMF with the returned address as the serving AMF of the target UE.

In step 3: The GMLC sends the LCS service request to the selected AMF, the serving AMF, which may include the Cell ID/gNB ID/TAI of the target area if it is available.

In step 4: If the UE is in CM IDLE state, the serving AMF initiates a network triggered Service Request procedure as defined in clause 4.2.3.3 of TS 23.502 of the 3GPP specification to establish a signalling connection with the UE. Therein, in a mobile network, when a device, such as a UE, does not have any ongoing data transmissions, it enters an IDLE state in order to preserve battery. If new data arrives for the device, the network probes the IDLE device by sending a so-called “paging” message and the device correspondingly responds.

In step 5: If the target UE couldn't be successfully paged at step 4, the serving AMF determines to invoke network assisted sidelink positioning to locate UE. The serving AMF selects at least one network assisted UE based on at least one of: the UE capability, cell ID/gNB ID/TAI of the target area, the last known cell ID of the target UE and the pre-configuration information.

In step 6: The serving AMF selects a LMF (location management function) capable of network assisted sidelink positioning.

In step 7: The serving AMF sends the LCS service request to the LMF which includes target UE ID and the at least one network assisted UE ID.

In step 8: When both the target UE ID and the at least one network assisted UE ID are received in the LCS service request, LMF sends the Ranging and/or Sidelink positioning request to the at least one network assisted UE to trigger the ranging and/or sidelink positioning procedure.

In step 9: The network assisted UE triggers the ranging and/or sidelink positioning procedure, which includes the discovery and service operation procedure over PC5.

In step 10: The at least one network assisted UE reports the Ranging and/or Sidelink positioning measurement or result to the LMF. LMF may receive measurement or result reported from more than one Network assisted UEs, LMF can determine whether to stop the further reporting from another network assisted UEs based on QoS requirement or pre-configuration.

In step 11: The LMF triggers one or more procedures for the positioning of at least one network assisted UE. The LCS location estimation for the target UE is generated based on at least one of: the Ranging and/or Sidelink positioning result, measurement data between target UE and one or multiple network assisted UEs, Uu positioning result, measurement data of one or more network assisted UEs.

In step 12: The LMF provides the LCS location estimation of the target UE to the GMLC.

In step 13: The GMLC provides the LCS location estimation of the target UE to the AF or LCS client.

It shall be understood that step 12 and step 13 might become optional if the LMF is able to directly communicate with the requesting device. (e.g., LMF transmit the LCS location estimation directly to the AF or LCS client).

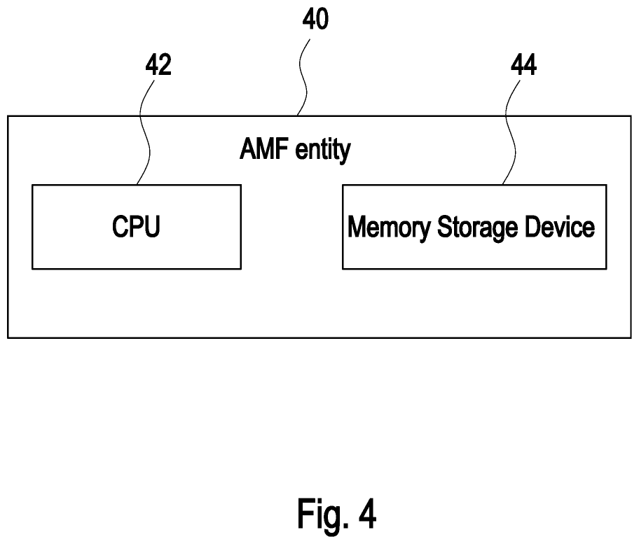

Referring to FIG. 4. FIG. 4 shows a schematic illustration of an AMF entity. The AMF entity 40 includes a processor 42 and a memory storage device 44. The memory storage device 44 may store a computer program or application containing instructions that, when executed, cause the processor 42 to perform operations such as those described herein. For example, the instructions may perform methods in accordance with the methods described herein. It will be understood that the instructions may be stored on a non-transitory computer-readable medium, such as a compact disc, flash memory device, random access memory, hard drive, etc. When the instructions are executed, the processor 42 carries out the operations and functions specified in the instructions so as to operate as a special-purpose processor that implements the described process(es). Such a processor may be referred to as a “processor circuit” or “processor circuitry” in some examples.

It shall be understood that other 5GC NF entities are also implemented in a similar manner as the AMF.

It is appreciated by those skilled in the art that the described functions in the embodiments of the present disclosure may be implemented by hardware, software, firmware or any combination thereof in the above one or more examples. When implemented by using the software, these functions may be stored in a computer-readable medium or transmitted as one or more instructions or codes on the computer-readable medium. The computer-readable medium may include a computer storage medium and a communication medium. The communication medium includes any medium that facilitates the transmission of a computer program from one place to another place. The storage medium may be any available medium that can be accessed by a universal or dedicated computer.

The present application also provides a non-transitory computer-readable storage medium storing processor-executed instructions that, when executed by a processor, cause the processor to perform the method in accordance with the methods described herein.

Certain adaptations and modifications of the described embodiments can be made. Therefore, the above discussed embodiments are considered to be illustrative and not restrictive. In particular, embodiments can be freely combined with each other.

It is to be understood that the term “multiple” in the present disclosure refers to more or more than two. The “and/or” is an association relationship for describing associated objects and represents that three relationships may exist. For example, A and/or B may represent the following three cases: only A exists, both A and B exist, and only B exists. The character “/” generally indicates that the related objects are in an “or” relationship.

Other embodiments of the present disclosure will be apparent to those skilled in the art from consideration of the specification and practice of the present disclosure disclosed here. This present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A network assisted method, comprising:
receiving, by an Access and Mobility Management Function (AMF), one or more registration requests from at least one User Equipment (UE);
receiving, by a Gateway Mobile Location Centre (GMLC), a Location Service (LCS) service request from a requesting device, wherein the LCS service request comprises information on a target UE;
determining, by a 5G Core Network Function, 5GC NF, the target UE is out of 5G coverage based on a serving AMF address retrieval result or a paging result;
selecting, by the GMLC, a serving AMF of the target UE based on the serving AMF address retrieval result;
transmitting, by the GMLC, the LCS service request to the serving AMF;
obtaining, by the serving AMF, at least one of: capability information of the at least one UE, cell ID, gNB ID, Tracking Area ID, or the last known ID of a target area;
selecting, by the serving AMF, at least one network assisted UE based on at least one of: capability information of the at least one UE, cell ID, gNB ID, Tracking Area ID, the last known ID of the target area, or a piece of pre-configuration information;
selecting, by the serving AMF, a Location Management Function (LMF) capable of network assisted sidelink positioning;
transmitting, by the serving AMF, the LCS service request to the LMF, wherein the LCS service request comprises a target UE ID and the at least one network assisted UE ID;
performing, by the LMF and the at least one network assisted UE, at least one of ranging procedure or sidelink positioning procedure;
generating, by the LMF, an LCS location estimation;
transmitting, by the LMF, the LCS location estimation of the target UE to the GMLC; and
transmitting, by the GMLC, the LCS location estimation to the requesting device.

2. The method according to claim 1, wherein generating, by the LMF, the LCS location estimation comprises:
obtaining an intermediate result from the at least one of ranging procedure or sidelink positioning procedure, wherein the intermediate result comprises at least one of: result of at least one of ranging or sidelink positioning, measurement data between the target UE and the at least one network assisted UE, Uu positioning result, or Uu measurement data of the at least one network assisted UE; and
generating the LCS location estimation based on the intermediate result.

3. The method according to claim 1, wherein performing, by the LMF and the at least one network assisted UE, at least one of ranging procedure or sidelink positioning procedure comprises:
discovering, by the at least network assisted UE, the target UE;
terminating, by the LMF, the discovering step in response to at least one report of successful discovery being received; or
terminating, by the LMF, the discovering step based on quality of service, QoS, requirement or a pre-configuration.

4. The method according to claim 1, wherein the LCS request further comprises information on a target area and the method further comprises:
mapping, by the GMLC, the information on the target area into at least one of: cell ID, gNB ID, or Tracking Area ID;
the selecting, by the GMLC, the serving AMF of the target UE based on the AMF address retrieval result further comprises:
selecting, by the GMLC, the serving AMF of the target UE based on at least one of: cell ID, gNB ID, or Tracking Area ID in response to no network address of the AMF being retrieved from a Unified Data Management, UDM.

5. The method according to claim 1, wherein the capability information of the at least one UE is included in the registration request, which is stored as the UE context of the at least one UE by the AMF.

6. The method according to claim 1, the method further comprising: checking, by the GMLC, service authorization and privacy with a Unified Data Management, UDM, upon receiving the LCS service request.

7. A network assisted method, implemented by an Access and Mobility Management Function (AMF) entity, the method comprising:
receiving, one or more registration requests from at least one User Equipment (UE);
receiving, from a Gateway Mobile Location Centre (GMLC), a Location Service (LCS) service request, wherein the LCS service request comprises information on a target UE;
obtaining at least one of: capability information of the at least one UE, cell ID, gNB ID, Tracking Area ID, or the last known ID of a target area;
selecting at least one network assisted UE based on at least one of: capability information of the at least one UE, cell ID, gNB ID, Tracking Area ID, the last known ID of the target area, or a piece of pre-configuration information;
selecting a Location Management Function (LMF) capable of network assisted sidelink positioning; and
transmitting the LCS service request to the LMF, wherein the LCS service request comprises a target UE ID and the at least one network assisted UE ID.

8. The method according to claim 7, wherein the capability information of the at least one UE is included in the registration request and the capability information is stored by the AMF as the UE context of at least one UE.

9. A network assisted method, implemented by a Location Management Function (LMF) entity and at least one network assisted User Equipment (UE), the method comprising:
receiving, by the LMF, from an Access and Mobility Management Function (AMF), a Location Service (LCS) service request, wherein the LCS service request comprises a target UE ID and at least one network assisted UE ID;
performing, by the LMF and the at least one network assisted UE, at least one of ranging procedure or sidelink positioning procedure;
generating, by the LMF, a LCS location estimation; and
transmitting, by the LMF, the LCS location estimation of the target UE to a Gateway Mobile Location Centre (GMLC) entity.

10. The method according to claim 9, wherein generating, by the LMF, the LCS location estimation comprises:
obtaining an intermediate result from the at least one of ranging procedure or sidelink positioning procedure, wherein the intermediate result comprises at least one of: results of at least one of ranging or sidelink positioning, measurement data between the target UE and the at least one network assisted UE, Uu positioning result, Uu measurement data of the at least one network assisted UE; and
generating the LCS location estimation based on the intermediate result.

11. The method according to claim 9, wherein performing, by the LMF and the at least one network assisted UE, at least one of ranging procedure or sidelink positioning procedure comprises:
discovering, by the at least one network assisted UE, the target UE;
terminating, by the LMF, the discovering step in response to at least one report of successful discovery being received; or
terminating, by the LMF, the discovering step based on at least one of quality of service, QoS, requirements or the pre-configuration information.

12. An Access and Mobility Management Function (AMF) entity, comprising:
a processor; and
a memory storing instructions executable by the processor,
wherein the processor is configured to perform the method according to claim 7.

13. A non-transitory computer-readable storage medium storing processor-executed instructions that, when executed by a processor, cause the processor to perform the method according to claim 1.

14. A network assisted system comprising at least one UE and at least one 5G core Network Function, 5GC NF entity, wherein the system is configured to perform the method according to claim 1.

15. A network assisted system comprising at least one Location Management Function (LMF) entity and at least one network assisted User Equipment (UE), wherein the system is configured to perform the method according to claim 9.

16. A non-transitory computer-readable storage medium storing processor-executed instructions that, when executed by a processor, cause the processor to perform the method according to claim 7.

17. A non-transitory computer-readable storage medium storing processor-executed instructions that, when executed by a processor, cause the processor to perform the method according to claim 9.
